(19) United States
(12) Patent Application Publication
(10) Pub. No.: US 2024/0026154 A1
(43) Pub. Date: Jan. 25, 2024

(54) POLYAMIDE COMPOSITIONS

(71) Applicants: Xilun Weng, Shanghai (CN); Hongyu Chen, Shanghai (CN); Ming Ming, Shanghai (CN); Yonghua Gong, Shanghai (CN); Wuye Ouyang, Shanghai (CN); Libo Du, Shanghai (CN); Shijie Ren, Shanghai (CN)

(72) Inventors: Xilun Weng, Shanghai (CN); Hongyu Chen, Shanghai (CN); Ming Ming, Shanghai (CN); Yonghua Gong, Shanghai (CN); Wuye Ouyang, Shanghai (CN); Libo Du, Shanghai (CN); Shijie Ren, Shanghai (CN)

(73) Assignee: Dow Global Technologies LLC, Midland, MI (US)

(21) Appl. No.: 18/255,122

(22) PCT Filed: Feb. 1, 2021
(86) PCT No.: PCT/CN2021/074724

§ 371 Date: May 31, 2023

(51) Int. Cl. C08L 77/06; C08K 3/013

(52) U.S. Cl. CPC C08L 77/06; C08K 3/013

(57) ABSTRACT

A nylon composition comprising a blend, wherein the blend includes: (a) at least one polyamide; and (b) at least one modifier, wherein the modifier includes a substantially linear functionalized ethylene/alpha-olefin copolymer having at least one side chain furan moiety crosslinked with at least one maleimide structure; a process for making the composition; and an article made from the composition.

### FIELD

The present invention relates to polyamide compositions comprising blends of a polyamide and a modifier; and more specifically, the present invention relates to a nylon composition comprising a combination or blend of a polyamide and a thermo-reversible cross-linking impact modifier for toughening the polyamide.

### BACKGROUND

Nylon is a well-known synthetic thermoplastic polymer based on aliphatic or semi-aromatic polyamides in which at least 85 percent by weight of the amide-linkages (—CO—NH—) are attached directly to two aliphatic groups. Nylon material can be melt-processed into various fibers, films, or shapes for forming articles/products and parts for use in various applications. For example, nylon polymers can be formed into shapes such as molded parts for cars, electrical equipment, and the like. For some applications, there is an increasing demand for articles/products and parts that are thinner than previously used articles/products and parts, and while at the same time, maintain the same high impact toughness as the original thicker articles/products and parts previously used. For example, users of nylon products are requesting from compounders to provide thin nylon products having a high impact toughness while maintaining the product's high flow and modulus, to enable the users to use such products for automotive and electrics applications. In the automotive industry, automakers are desirous of smaller parts with thinner walls to reduce vehicle weight which, in turn, can improve auto fuel economy and/or lower carbon footprint; and in the electrics industry, manufacturers are desirous of using smaller components with thinner walls to reduce the weight of electrical components.

While nylon polymers can be mixed with a wide variety of additives to achieve many different property variations, one way to increase the impact toughness of articles/products and parts is to first add a crosslinking agent as a toughening additive (or impact modifier) to a nylon polymer to form a blend of nylon and modifier composition and then use the blended composition to make articles/products and parts having a high impact toughness.

For example, JP2014034615A discloses a thermoplastic elastomer, a method for producing the thermoplastic elastomer, and an electric wire and cable. JP2014034615A illustrates a thermoplastic elastomer, used for electric wire and cable, wherein the elastomer is combination of (1) a halogen-containing elastomer in which a conjugated diene structure is bonded in the elastomer's principal chain through an amino group, and (2) a crosslinking agent having dienophile structures. The above reference discloses an insulator in the form of a neat material for wire and cable. For instance, a sheath is formed from the elastomer to serve as the insulator. And, the reference discloses halogenated rubbers used as the elastomer but does not teach non-halogenated elastomers.

U.S. Pat. No. 6,512,051(B2) discloses an elastomer composition having a functional group that forms a reversible cross-link of a Diels-Alder (DA) type reaction which is triggered with temperature. Reversible crosslinking relates to a crosslinking structure that can dissociate at high temperature (e.g., >150° C.) and associate at low temperature (e.g., <150° C.). The base polymer (elastomer) disclosed in the above patent is butadiene rubber, adopting furfurylmercaptan and bismaleimidodiphenylmethane. The clear structure is identified by NMR, FTIR, and rheology; and mechanical tests indicate the reversibility of this type of DA-modified elastomer. While the above patent discloses a chemistry similar to DA chemistry, the patent only discloses the use of rubber as the elastomer; and does not teach nylon compounds or the use of rubber as a toughening agent for nylon compounds.

CN109535626A discloses chemistry similar to DA chemistry using a solution and does not disclose a melt (i.e., a molten material). Also, the above reference only discloses the use of rubber as the elastomer; and does not teach nylon compounds or the use of rubber as a toughening agent for nylon compounds.

U.S. Pat. No. 10,100,133B2 discloses the general concept of thermo-reversibility using azide chemistry and does not disclose a DA-type modified elastomer. Also, the above patent does not disclose any other type of toughening agent.

It is, therefore, desired to provide a toughening agent for use with a nylon material to increase the toughness property of the nylon material by combining the toughening agent (also referred to as an impact modifier compound), with the nylon material to form a toughened nylon polymer composition.

### SUMMARY

One embodiment of the present invention is directed to a nylon polymer composition including a nylon compound blended with an impact modifier (a toughening agent) compound; wherein the impact modifier provides the nylon polymer composition with: (1) a thermo-reversibility property via a reversible crosslink Diels-Alder (DA) type reaction; and (2) an increased toughening property. In a preferred embodiment, the impact modifier is a substantially linear functionalized ethylene/alpha-olefin copolymer having at least one side chain comprising a furan moiety crosslinked with at least one maleimide structure.

In one or more other embodiments, the nylon polymer composition of the present invention includes a blend comprising, for example: (a) from 70 weight percent (wt %) to 98 wt %, based on the weight of components (a) and (b), of a polyamide; and (b) from 2 wt % to 30 wt % of a modifier, based on the weight of components (a) and (b), wherein the modifier is a substantially linear functionalized ethylene/alpha-olefin copolymer having at least one side chain comprising a furan moiety crosslinked with at least one maleimide structure.

In one or more other embodiments, the present invention includes a process for manufacturing the above impact modifier and the above nylon polymer composition having a thermo-reversibility property and an increased toughening property.

In still one or more other embodiments, the present invention includes an article produced using the above nylon polymer composition. In one or more preferred embodiments of the above article production processes of the present invention includes an extrusion process.

Additional features and advantages of the embodiments of the present invention are set forth in the detailed description which follows, and in part will be readily apparent to those skilled in the art from that description or recognized by practicing the embodiments described herein, including the detailed description and the claims.

### DETAILED DESCRIPTION

“Elastomeric” or “elastomer’ or “polyolefin elastomer (POE)” as used herein with reference to a polymer, means an ethylene/alpha (α)-olefin (EAO) polymer or EAO polymer blend that has a density that is beneficially less than about 0.920 g/cm³ in one general embodiment, less than about 0.900 g/cc in another embodiment, less than about 0.895 g/cm³ in still another embodiment, less than about 0.880 g/cc in yet another embodiment, less than about 0.875 g/cm³ in even still another embodiment, and less than about 0.870 g/cm³ in yet another embodiment; and a percent (%) crystallinity of less than 33% in one general embodiment, less than 29% in another embodiment and less than about 23% in still another embodiment. The density is generally greater than about 0.850 g/cm³. Percent crystallinity is determined by differential Scanning calorimetry (DSC).

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, and the like. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “Diels-Alder (DA) reaction” is a chemical reaction between a conjugated diene and a substituted alkene to form a substituted cyclohexene derivative. This reaction is used to produce a modifier which can increase the impact toughness of articles/products and parts using a method of reversible crosslinking, for example via a Diels-Alder (DA) reaction triggered with temperature. Reversible crosslinking relates to and offers a crosslinking structure that can dissociate at high temperature (e.g., >150° C.) and associate at low temperature (e.g., <150° C.), providing a composition having high flow during processing and a high growth of molecular weight after cooling down the composition resulting in a composition with superior toughening. A DA reaction is thermo-reversible when applied to a polymer composition. The DA reaction can provide reversible cross-linking functionality while allowing a reactive composition to undergo relatively fast kinetics and mild reaction conditions.

“Thermo-reversibility” or “thermo-reversible” herein means a reversible reaction triggered by temperature.

“Room temperature (RT)” and/or “ambient temperature” herein means a temperature between 20° C. and 26° C., unless specified otherwise. Temperatures used herein are in degrees Celsius (° C.).

The term “composition” refers to a mixture of materials which comprise the composition, as well as reaction products and decomposition products formed from the materials of the composition.

A “nylon polymer composition” herein means a nylon polymer which is melt-blended with an impact modifier to result in a heterogeneous blend of nylon and the impact modifier.

The term “impact toughness” or “impact strength” herein means the amount of energy that a material can withstand when a load is suddenly applied to the material. The term may also be defined as the threshold of force per unit area before the material undergoes fracture.

An “impact modifier” or “modifier” herein means a substantially linear functionalized ethylene copolymer useful for modifying the room temperature impact strength of another polymer such as a polyamide.

“Room temperature impact strength” herein means impact strength tested at room temperature (RT) conditions, e.g., at 23° C. and 50% relative humidity (RH).

“Substantially linear functionalized ethylene/alpha-olefin copolymer”, with reference to a polymer composition, herein means are characterized by narrow molecular weight distribution (MWD) and narrow short chain branching distribution (SCBD). In one embodiment, the substantially linear functionalized ethylene copolymer may be prepared, for example, using the procedure described in U.S. Pat. Nos. 5,272,236 and 5,278,272.

“Substantially linear”, with reference to a polymer, herein means that a polymer has a back bone substituted with from 0.01 to 3 long-chain branches per 1,000 carbons in the backbone.

A “POE-g-MAH” compound or component herein means a POE grafted with at least one maleic anhydride (MAH) to form a MAH grafted POE or POE-g-MAH.

A “POE-g-FFA” compound or component herein means a POE grafted with at least one furan compound such as furfurylamine (FFA) to form a FFA grafted POE or POE-g-FFA.

A “substantially linear functionalized ethylene/alpha-olefin copolymer (SLFC) having at least one side chain comprising a furan moiety crosslinked with at least one maleimide structure” herein means an impact modifier comprising a modified POE-g-MAH having furan moieties and maleimide structures to provide a polymer having DA reaction properties.

“Furan” is a heterocyclic organic compound, consisting of a five-membered aromatic ring with four carbon atoms and one oxygen as shown by the general chemical structure of Formula (I). Chemical compounds containing such rings are also referred to as furans.

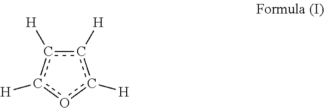

“Furan conversion level”, with reference to a polymer composition, herein means the conversion ratio from maleic anhydride to imide ring after furfurylamine is added to a maleic anhydride group containing compound.

A “high performance” polyolefin elastomer herein means a toughening performance measured as an increase in RT impact strength according to CHARPY ISO 179-1 of at least ≥10%.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “±” means “plus or minus”; “@” means “at”; μm=micron(s), g=gram(s); mg=milligram(s); g/L=gram(s) per liter; “g/cm³” or “g/cc”=gram(s) per cubic centimeter; “kg/m³=kilogram(s) per cubic meter; ppm=parts per million by weight; pbw=parts by weight; rpm=revolutions per minute; m=meter(s); mm=millimeter(s); cm=centimeter(s); μm=micrometer(s); min=minute(s); s=second(s); ms=millisecond(s); hr=hour(s); Pa=pascals; MPa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; psig=pounds per square inch; kPa=kilopascal(s); %=percent; vol %=volume percent; mol %=mole percent; wt %=weight percent; and KJ/m²=kilojoules per meter squared.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

In general, the present invention includes a nylon formulation or composition useful for producing nylon articles/products or parts having an increase in toughness for various applications such as for producing automotive parts. The nylon composition comprises a combination, mixture or blend of: (a) at least one polyamide (i.e., a nylon); and (b) at least one impact modifier. In one preferred embodiment, the nylon composition includes, for example, a blend of: (a) from 70 wt % to 98 wt %, based on the weight of components (a) and (b), of at least one polyamide compound such as a nylon material; and (b) from 2 wt % to 30 wt % of at least one impact modifier, based on the weight of components (a) and (b), wherein the impact modifier, component (b), is a substantially linear functionalized ethylene/alpha-olefin copolymer having at least one side chain comprising a furan moiety crosslinked with at least one maleimide structure.

The nylon composition of the present invention may further include (c) one or more other compounds, if desired.

The terms “nylon” and “polyamide” are used herein interchangeably.

The polyamide compound, component (a) of the nylon composition, is a polymer, which contains recurring amide groups (R—CO—NH—R′) as integral parts of the main polymer chain. The polyamide compound useful in the present invention can include one or more polyamide compounds. For example, the polyamide can be selected from the group consisting of a nylon polymer including Nylon 6 (a polycaprolactam which is made from caprolactam which self-polymerizes); Nylon 6,6 (a hexamethylene diamine-adipic acid condensation product which is a long chain synthetic polyamide having recurring amide groups in the polymer backbone); Nylon 4; Nylon 11; Nylon 12; Nylon 6,10; Nylon 4,6, Nylon 6I, Nylon 6T; Nylon 9T; or combinations thereof. In one preferred embodiment, the polyamide compound useful in the present invention is Nylon 6; Nylon 6,6; or mixtures thereof.

Exemplary of some of the commercial polyamide compounds useful in the present invention can include, for example, Zytel 7304 NC010 (available from Dupont); PA6-YH800 (available from Yueyang Baling Shihua Chemical & Synthetic Fiber Co. Ltd.); and mixtures thereof.

The concentration of the polyamide compound, component (a), used in preparing the nylon composition of the present invention includes, for example, from 42 wt % to 97 wt % based on the weight of components (a) and (b) in one embodiment, from 50 wt % to 90 wt % in another embodiment, and from 65 wt % to 84 wt % in still another embodiment.

In one embodiment, the impact modifier, component (b), includes, for example, a base polymer that is modified or functionalized with furan moieties and maleimide moieties to form a substantially linear functionalized ethylene/alpha-olefin copolymer having at least one side chain furan moiety crosslinked with at least one maleimide structure. The impact modifier comprising the substantially linear functionalized ethylene/alpha-olefin copolymer having at least one side chain furan moiety crosslinked with at least one maleimide structure, is herein referred to as the “substantially linear functionalized copolymer (SLFC)”.

In one general embodiment, the impact modifier used in the present invention is produced by modifying a base polymer such as a polyolefin elastomer (POE) using various components and various grafting and/or compounding techniques to produce the SLFC impact modifier. For example, in a preferred embodiment the SLFC impact modifier used in the present invention is produced by modifying (bi) at least one a POE-g-MAH with (bii) at least one furan compound such as furfurylamine (FFA) for grafting the FFA onto the POE-g-MAH to form a POE-g-FFA; and then compounding the POE-g-FFA with (biii) at least one maleimide compound such as 1,1′-(methylenedi-4,1-phenylene)bismaleimide for compounding with the POE-g-FFA to form the SLFC.

In one preferred embodiment, the process of producing the SLFC impact modifier includes the steps of:
(A) providing a POE-g-MAH, component (bi), by either (1) grafting a POE with at least one maleic anhydride (MAH) to form the MAH grafted POE (POE-g-MAH); or (2) by procuring a commercially available POE-g-MAH compound such as Exxelor VA 1801 or Exxelor VA 1803 available from ExxonMobil;
(B) grafting the POE-g-MAH from step (A) with the at least one furan compound, component (bii), such as FFA, to form a furan moiety grafted polyolefin elastomer (e.g., POE-g-FFA); and
(C) compounding the resulting POE-g-FFA from step (B) with at least one maleimide compound, component (biii), such that at least one side chain furan moiety of the POE-g-FFA crosslinks with at least one maleimide structure of the maleimide compound to form the final SLFC impact modifier.

For example, in step (B) above, the POE-g-MAH is grafted with FFA resulting in an FFA-grafted polyolefin elastomer or FFA functionalized POE (POE-g-FFA). The final impact modifier comprising the substantially linear functionalized ethylene/alpha-olefin copolymer having at least one side chain furan moiety in the SLFC has a furan conversion level of at least 80% in one embodiment, from 80% to 95% in another embodiment, and from 80% to 90% in still another embodiment.

The above grafting step (B), to functionalize a POE-g-MAH with FFA forming a POE-g-FFA product, can be illustrated with the following Reaction Scheme (I):

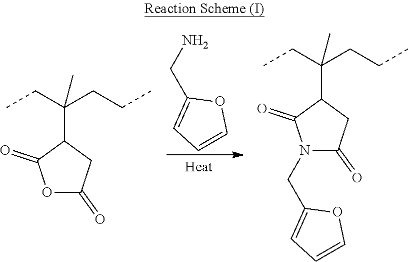

Once the above POE-g-MAH is functionalized with FFA forming a POE-g-FFA product, the impact modifier production process includes the above step (C) of compounding the POE-g-FFA and a maleimide compound such as a bismaleimide (BMI) compound. For example, in one preferred embodiment, POE-g-FFA can be compounded with a BMI compound, component (biii), such as 1,1′-(methylenedi-4,1-phenylene)bismaleimide as illustrated in the following general Reaction Scheme (II):

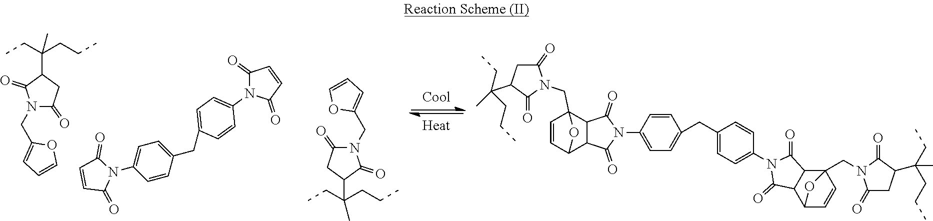

The base polymer used to form the SLFC includes for example an elastomeric ethylene/alpha (α)-olefin (EAO) polymer (also referred to as an “ethylene polymer” or a polyolefin elastomer (POE). The POE polymers useful in preparing the SLFC of the present invention include, for example, interpolymers and diene modified interpolymers. Illustrative base polymers include, for example, ethylene/octene (EO) copolymers; ethylene/hexene (EH) copolymers; ethylene/propylene/diene modified (EPDM) interpolymers; and mixtures thereof.

In other embodiments, the EAO polymers may include, for example, linear low density polyethylene (LLDPE) homogeneously branched, linear EAO copolymers (e.g., Tafmer polymers available from Mitsui PetroChemicals Company Limited and Exact polymers available from Exxon Chemical Company); and homogeneously branched, substantially linear EAO polymers (such as ENGAGE™ polymers available from The Dow Chemical Company). In a preferred embodiment, the EAO polymers used in the present invention are homogeneously branched linear and substantially linear ethylene copolymers with a density (measured in accordance with ASTM D-792) of from 0.85 g/cm³ to 0.92 g/cm³ in one embodiment, and from 0.85 g/cm³ to 0.90 g/cm³ in another embodiment; and a melt index (MI or 12) (measured in accordance with ASTM D-1238 (190° C./2.16 kg weight) of from 0.01 g/10 min to 30 g/10 min in one embodiment and from 0.05 g/10 min to 10 g/10 min in another embodiment.

In one embodiment, the POE-g-MAH compound useful as one of the components for forming the impact modifier, may be formed by grafting a maleic-anhydride compound (MAH) onto a POE component using conventional grafting methods known in the grafting art to form the POE-g-MAH, component (bi).

In another embodiment, the POE-g-MAH compound useful as component (bi) for producing the impact modifier of the present invention can include, for example, any of the commercially available POE-g-MAH compounds available from The Dow Chemical Company; any of the commercially available POE-g-MAH compounds, such as Exxelor VA 1801 or Exxelor VA 1803, available from ExxonMobil; and mixtures thereof.

In some embodiments, some of the properties of the POE-g-MAH compound useful in the present invention include, for example, the following: the MAH level of the POE-g-MAH compound can be, for example, from 0.3 wt % to 1.5 wt % in one general embodiment, from 0.3 wt % to 1.2 wt % in another embodiment, from 0.3 wt % to 0.9 wt % in still another embodiment; and from 0.8 wt % to 0.9 wt % in yet another embodiment.

The density of the POE-g-MAH compound can be, for example, from 0.84 g/cm³ to 0.88 g/cm³ in one general embodiment; from 0.85 g/cm³ to 0.88 g/cm³ in another embodiment; and from 0.85 g/cm³ to 0.87 g/cm³ in still another embodiment.

The melt index (MI) of the POE-g-MAH compound can be, for example, from 0.2 g/10 min to 30 g/10 min in one general embodiment; from 0.2 g/10 min to 20 g/10 min in another embodiment; from 0.2 g/10 min to 10 g/10 min in still another embodiment; from 0.2 g/10 min to 5 g/10 min in yet another embodiment; from 0.2 g/10 min to 3 g/10 min in even still another embodiment; and from 0.2 g/10 min to 2 g/10 min in even yet another embodiment.

The furan compound (i.e., compounds containing furan moieties), component (bii), useful for preparing the POE-g-FFA, one of the components useful for producing the impact modifier of the present invention, can include one or more compounds, including, for example, FFA.

The concentration of the FFA compound used to prepare the POE-g-FFA includes, for example, from 0.2 wt % to 5 wt %, based on the total weight of components (bi) and (bii), in one general embodiment.

The present invention includes the use of DA chemistry as a thermo-reversible cross-linking tool to build up dynamic high molecular weight of, for example, the POE-g-FFA compound, and then to toughen a nylon compound using the POE-g-FFA compound in a nylon composition. For example, the reactivity of a POE-g-FFA enables introduction of a degree of DA functionality into the POE-g-FFA compound without sacrificing the flowability of the composition. It is hypothesized that the POE-g-FFA compound provides a reversible crosslinking technique that can mitigate the tradeoff between high toughness for nylon and the sacrifice of the composition's flowability by offering an impact modifier that provides a crosslinking structure that can effectively dissociate at high (e.g., >150° C.) temperature and associate at low (e.g., <150° C.) temperature. The POE-g-FFA provides a high flow composition during processing of the composition at a high temperature; and grows the high molecular weight for the composition (to increase toughness) after cooling down the composition to a low temperature. Therefore, the reversible crosslinking technique, can be successfully applied to a nylon composition, especially when an article made from the composition and requires having a thinner wall. The reversible crosslinking technique can improve the stiffness-toughness-flowability balance, e.g., a decreased POE-g-FFA loading can provide the same or better stiffness-toughness-flowability for a non-crosslinked nylon compound with similar stiffness and flowability. In addition, since the trigger temperature of DA covalent bonds is above 150° C., generally a higher melting strength for the resulting crosslinked polymer can be obtained compared to a non-crosslinked polymer. Also, the HDT performance of the nylon composition can be enhanced using the POE-g-FFA.

The maleimide compound, component (biii), can include one or more compounds, including, for example, 1,1′-(methylenedi-4,1-phenylene)bismaleimide; bis-maleimidoethane BM(PEG)3 (1,11-bismaleimido-triethyleneglycol); BM(PEG)2 (1,8-bismaleimido-diethyleneglycol); DTME (dithio-bis-maleimidoethane); 3,3′-sulfinylbis(N-(2-(2,5-dioxo-2,5-dihydro-1H-pyrrol-1-yl)ethyl)propanamide); N,N′-(1,3-phenylene)dimaleimide; N,N′-(4-methyl-1,3-phenylene)bismaleimide; 1,1′-(3,3′-dimethyl-1,1′-biphenyl-4,4′-diyl)bismaleimide; 2-[8-(3-hexyl-2,6-dioctylcyclohexyl)octyl]pyromellitic diimide oligomer (maleimide terminated, lower viscosity); and mixtures thereof.

In one preferred embodiment, the maleimide compound useful in the present invention can be 1,1′-(methylenedi-4,1-phenylene)bismaleimide; BM(PEG)3 (1,11-bismaleimido-triethylene-glycol) and mixtures thereof.

The concentration of the maleimide compound, component (biii), used in preparing the impact modifier of the present invention includes, for example, from 0.2 wt % to 3.0 wt %, based on the total weight of the components (bii) and (biii), in one general embodiment; and from 0.5 wt % to 1.5 wt % in another embodiment.

Exemplary of some advantageous properties exhibited by the impact modifier compound of the present invention include an impact modifier compound having a high impact strength or toughening in accordance with the Charpy test of, for example, greater than at least ≥10 percent (%) increase in RT impact strength according to CHARPY ISO 179-1 in one embodiment; from 10% to 15% in another embodiment, from 10% to 20% in still another embodiment, from 10% to 30% in yet another embodiment; from 10% to 40% in even still another embodiment, from 10% to 50% in even yet another embodiment; and from 10% to 60% in another embodiment.

The concentration of the impact modifier compound, component (b), blended with the nylon compound, component (a), to prepare the nylon composition of the present invention includes, for example, from 1 wt % to 50 wt %, based on the weight of components (a) and (b), in one embodiment; from 3 wt % to 30 wt % in another embodiment, and from 5 wt % to 20 wt % in still another embodiment.

If desired, the nylon compositions of the present invention may be compounded with any one or more optional materials, components, additives or agents conventionally added to polymers. The optional compounds, component (c), useful in the nylon composition of the present invention can include, for example, other non-modified EAOs; antioxidants; reinforcement fillers such as glass fiber, calcium carbonate, talc, silicon limestone, mica and the like; flame retardants; ultraviolet additives; pigments; process oils, plasticizers, lubricants, mold release agents and the like; and mixtures thereof. These materials may be compounded with the nylon compositions of the present invention either before or after such nylon compositions are mixed with the impact modifier. Skilled artisans can readily select any suitable combination of additives and additive amounts as well as timing of compounding without undue experimentation.

For example, in one preferred embodiment, a filler can be added to the nylon composition. The filler can be selected from, for example, the group consisting of glass fiber, calcium carbonate, calcium silicate, calcium sulfate, magnesium carbonate, barium sulfate, barite, alumina, hydrated alumina, mica, clay, silica or glass, fumed silica, titanium dioxide, titanates, talc, flame retardants, carbon black or graphite, antimony oxide, magnesium hydroxide, borates, and combinations thereof.

In general, the filler useful in the present invention is selected to provide a contribution to mechanical strength and stiffness to a part; and to control part shrinkage. To improve the stiffness/toughness balance in a nylon composition of the present invention a talc with a high aspect ratio (HAR) is used. The HAR talc filler can provide the required stiffness level at a reduced addition level, further contributing to weight reduction due to lower compound density. A lower filler addition level also allows for better flow of nylon composition of the present invention.

The talc filler, when combined with the impact modifier of the present invention, the combination can provide the higher stiffness/toughness balance for thinner and downgauged parts at the required higher flow compared to standard TPO compounds. In addition, more complex geometries are enabled with such high flow nylon compositions. Metal replacement for exterior parts of cars is another benefit of using the nylon composition of the present invention. Still, other benefits of using the nylon composition of the present invention includes lightweighting and better manufacturing efficiency.

The concentration of the filler in the composition can be up to 50 wt %, based on the composition. In general, the concentration of the optional compounds, component (c), when used in the composition includes, for example, from 0 wt % to 50 wt % in one embodiment, from 0.1 wt % to 40 wt % in another embodiment, from 1 wt % to 35 wt % in still another embodiment, and from 1 wt % to 10 wt % in yet another embodiment.

The impact modifier is designed to enhance the impact performance of, add flexibility to, and increase filler capacity in a nylon composition. The impact modifier advantageously functions as a toughening agent for the nylon composition, i.e., the POE-g-FFA/maleimide structure can be an effective impact modifier to increase the low temperature toughness of a variety of polymer compounds such as nylon and nylon compositions. In one embodiment for example, the impact modifier can: (1) provide a high toughening efficiency for a nylon compound, and (2) improve the toughness-flowability balance of the nylon compound.

In a general embodiment, the nylon composition containing the SLFC as an impact modifier advantageously exhibits at least a 10% improvement in RT impact strength compared to a nylon composition containing an unmodified substantially linear functionalized ethylene/alpha-olefin copolymer having no side chain furan moieties and no side chain maleimide structures. In another embodiment, the impact modifier exhibits at least a 15% improvement in RT impact strength; and in still another embodiment, the impact modifier exhibits at least a 20% improvement in RT impact strength.

Because of the above improved RT impact strength, the nylon composition can be used to manufacture lightweight articles/products or parts with thinner walls and using less composition. Some other advantageous properties and/or benefits of the composition of the present invention include, for example, better high temperature resistance, better flexure, and better flowability.

The general process for producing the nylon composition of the present invention includes the step of admixing, combining or blending: (a) at least one polyamide; and (b) a SLFC impact modifier. In one embodiment, the polyamide used as component (a) is a nylon compound or nylon composition; and the impact modifier used as component (b) is a substantially linear functionalized ethylene/alpha-olefin copolymer having at least one side chain comprising a furan moiety crosslinked with at least one maleimide structure.

In a preferred embodiment, the process of manufacturing the nylon composition comprises the step of blending: (a) from 70 wt % to 98 wt %, based on the weight of components (a) and (b), of a polyamide; and (b) from 2 wt % to 30 wt % of a modifier of the present invention, based on the weight of components (a) and (b), wherein the modifier is a substantially linear functionalized ethylene/alpha-olefin copolymer having at least one side chain furan moiety and at least one side chain maleimide structure. For example, the process comprises mixing the components (a) and (b), each of the components being in a molten state at a temperature of from 230° C. to 350° C. to form a uniform or homogeneous mixture. Conventional mixing equipment used by those skilled in the field of mixing is used in the mixing step described above.

Once components (a) and (b) of the toughened nylon composition of the present invention are thoroughly and uniformly mixed together as described above, the resulting molten mixture can be used to form an article/product or a shaped part using a conventional process and equipment. For example, an injection molding, compression molding, extrusion molding, or blow molding process can be used to form the article/product or the shaped part from the composition. In one preferred embodiment, the article/product or the shaped part is produced and processed, for example, using an injection molding process and extrusion equipment such as a twin screw extruder as well known in the art. The resulting article, produced using the above process, has a RT impact strength (toughness property) of from 44 KJ/m² to 75 KJ/m² in one embodiment; from 40 KJ/m² to 65 KJ/m² in another embodiment; and from 50 KJ/m² to 80 KJ/m² in still another embodiment.

The toughened nylon composition of the present invention can be used to form an article/product or a shaped part for various applications. For example, the toughened article/product or part produced from the nylon composition can be used in applications including, but not to be limited thereby, automotive applications such as automotive rigid articles or parts with outstanding low temperature impact performance for interior and exterior applications; electric applications such as wire and cable coatings with enhanced physical properties; molded goods applications, such as packaging, toys or household appliances; profile extruded goods applications such as tubing that is flexible and transparent; roofing membranes that are flexible and tough; motorcycle components, boat components, airplane components, tools, sports equipment, personal protective equipment such as safety helmets, sportswear, electronic equipment, machine housings, luggage, castor wheels, gears, and bearings.

In general, the nylon composition of the present invention is used in applications where there is a requirement for parts with a high impact strength (i.e., an increased toughness and durability) over parts made from conventional copolymers. In one preferred embodiment, the article/product produced from the nylon composition of the present invention as described above is used in automotive applications including, for example, automotive rigid articles or parts such as bumper fascia, instrument panel, body panels and airbag covers.

The nylon composition of the present invention is also useful in the auto industry because, by using the composition, Original Equipment Manufacturers (OEMs) can further reduce the weight of existing plastic parts made from the composition; and/or to replace metal parts.

To create thinner and consequently lighter parts, it is required that nylon compositions flow through thinner walls. Improvement of both flow properties and toughness is obtained using the nylon composition of the present invention. Such high performance allows for downgauging interior and exterior car parts that require outstanding impact properties.

### EXAMPLES

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The examples of the present invention are identified by Arabic numerals and the comparative examples are represented by letters of the alphabet. The following experiments analyzed the performance of embodiments of compositions described herein. Unless otherwise stated all parts and percentages are by weight on a total weight basis.

Various raw materials or ingredients used in the Examples are explained in Table I as follows:

TABLE I
Raw Materials

| Ingredient | Brief Description | Supplier |
|---|---|---|
| Zytel 7304 nc010 | Nylon6 | DuPont |
| PA6-YH800 | Nylon6 | Yueyang Baling Shihua |
| | | Chemical & Synthetic Fiber |
| | | Co. Ltd. |
| POE-g-MAH1 | Substantially linear functionalized | The Dow Chemical |
| | ethylene-octene copolymer with 0.8 | Company |
| | wt % maleic anhydride (MAH) grafted | |
| | to the copolymer | |
| POE-g-MAH2 | Substantially linear functionalized | The Dow Chemical |
| | ethylene-octene copolymer with 0.4 | Company |
| | wt % MAH grafted to the copolymer | |
| furfurylamine | A functional modifier | TCI |
| 1,1′-(methylenedi-4,1- | A reversible crosslinker | OKA |
| phenylene)bismaleimide | | |

### General Process for Producing the Modifiers

The components of the impact modifier compositions (designated as “Modifier 1, 2, 3 and 4”) used in the Examples are described in Table II. The POE-g-MAH1 and POE-g-MAH2 are maleic anhydride (MAH) grafted polyolefin elastomer compounds which are proprietary to and available from The Dow Chemical Company.

TABLE II
Modifier Compositions

| | Modifier | Modifier | Modifier | Modifier |
|---|---|---|---|---|
| | 1 | 2 | 3 | 4 |
| Component | (wt %) | (wt %) | (wt %) | (wt %) |
| POE-g-MAH1 | 100 | 97.5 | | |
| POE-g-MAH2 | | | 100 | 98.75 |
| furfurylamine | | 1 | | 0.5 |
| 1,1′-(methylenedi-4,1- | | 1.5 | | 0.75 |
| phenylene)bismaleimide) | | | | |

The modifiers using the components described in Table II were prepared according to the following general procedure:

A Leistritz twin screw extruder, ZSE27, having a L/D=48, and D=27 mm was used for reactive extrusion. A POE-g-MAH compound (POE-g-MAH1 or POE-g-MAH2) was fed into the extruder through a main port of the extruder. Furfurylamine was fed into the extruder using a liquid pump after the resin was molten. The speed of the twin-screw extruder was set at 250 rpm. The feed rate of the POE-g-MAH resin to the extruder was set at 10 kg/h and the barrel temperatures of the extruder were set in the range of from 120° C. to 180° C. in order to yield a melt temperature of from 120° C. to 250° C. in one embodiment, from 150° C. to 250° C. in another embodiment, and from 180° C. to 250° C. in still another embodiment. The furfurylamine was grafted to the POE-g-MAH (POE-g-MAH1 or POE-g-MAH2) via a reaction between the furfurylamine and the MAH groups of the POE-g-MAH compound. After extrusion, the resulting POE-g-FFA product from the extruder was pelletized to form pellets. The POE-g-FFA pellets were collected from the pelletizer and then dried at 40° C. for 12 hr in a de-humidifier system.

The compound 1,1′-(methylenedi-4,1-phenylene)bismaleimide in solid powder form was compounded with the POE-g-FFA pellets described above and the resultant compounded mixture was then pelletized to form the SLFC impact modifier of the present invention in pellet form. The process conditions for compounding and pelletizing the modifier were the same as described above. The impact modifiers of the present invention, which were produced in accordance with the above process, comprise a reversible crosslinked elastomer.

The impact modifiers produced according to the process described above were analyzed using Fourier-transform infrared (FTIR) spectroscopy described below to confirm the chemical structure of the modifiers. Table III describes the FTIR data for the impact modifier using POE-g-MAH1 and Table IV describes the FTIR data for the impact modifier using POE-g-MAH2.

TABLE III
Characterization of Impact Modifier Using POE-g-MAH1

| | Integrated Peak Area | | |
|---|---|---|---|
| FTIR Data | 2114-1967 | | Normalized |
| Wavelength of | (cm⁻¹), | 1820-1755 | MAH |
| integrated | film thickness | (cm⁻¹), | Peak Area |
| peak area | peak | MAH peak | 1820-1755 (cm⁻¹) |
| POE-g-MAH1 | 0.52 | 7.1 | 13.6 |
| POE-g-FFA1 | 1.48 | 5.6 | 3.8 |
| DA modified | 0.96 | 3.8 | 3.9 |
| POE-g-FFA1 | | | |

TABLE IV
Characterization of Impact Modifier Using POE-g-MAH2

| | Integrated Peak Area | | |
|---|---|---|---|
| FTIR Data | 2114-1967 | | Normalized |
| Wavelength of | (cm⁻¹), | 1820-1755 | MAH |
| integrated | film thickness | (cm⁻¹), | Peak Area |
| peak area | peak | MAH peak | 1820-1755 (cm⁻¹) |
| POE-g-MAH2 | 0.67 | 4.6 | 6.9 |
| POE-g-FFA2 | 0.51 | 1.1 | 2.2 |
| DA modified | 0.88 | 1.85 | 2.1 |
| POE-g-FFA2 | | | |

### Test Methods and Measurements

Samples of the compositions and test specimens made from the compositions described above and used in the Examples were subjected to the following test methods:

### FTIR Characterization

Fourier-transform infrared (FTIR) spectroscopy is used in the Examples to procure an infrared spectrum of either the emission or absorption of a test sample. The sampling technique of attenuated total reflection (ATR) is used alongside the FTIR spectroscopy, which ultimately qualifies samples to be observed directly in either in the solid state or liquid state, without additional preparation.

The instrumentation used in the Examples for the ATR-FTIR analysis is a Perkin Elmer Spectrum Spotlight 200 with Smart DuraSamplIR Diamond ATR (available from Perkin Elmer). A sample being analyzed is placed on a Diamond/ZnSe crystal, an appropriate pressure is applied to the sample to acquire optimum contact, and then an ATR-FTIR spectrum is collected between 4,000 cm−1 and 650 cm−1. Each of the samples analyzed were scanned 8 times. The FTIR spectra data is then analyzed.

### Impact Method

The sample compositions of the Examples were tested for impact performance using the procedure described in CHARPY ISO 179 (“ISO” stands for “International Organization for Standardization”). ISO 179 specifies a method for determining the Charpy impact strength of plastics under defined conditions. The specimen used in this test is a flat test specimen made from the compositions of Table V with the following dimensions: 63.5 mm length×10 mm width×4 mm thickness.

CHARPY ISO 179-1 defines the method used to determine the resistance of plastic to breaking when impacted in a three-point bend configuration, using a pendulum system with an appropriately sized hammer arm. The test is un-instrumented and is used to determine the energy required to break the specimen. Different test parameters are specified according to the type of material that the specimen is made of as well as the type of notch cut in the specimen.

The specimen is mounted horizontally and supported unclamped at both ends of the specimen. A hammer arm is released and allowed to strike through the specimen. If breakage of the specimen does not occur with the first hammer arm used, subsequent individual hammer arms heavier than the first hammer arm are used sequentially until failure/breakage of the specimen occurs. Then, the resulting energy and break types are recorded. Prior to impact testing at RT, the test specimens are first conditioned at 23° C. and 50% RH for at least 40 hr. Subsequently, the test specimens are tested at 23° C. immediately following the conditioning period. The impact testing is carried out at a pendulum capacity of 4 Joules.

In the case of impact testing at −30° C., the test specimens are first conditioned at 23° C. and 50% RH for a first conditioning period of at least 40 hr, followed by another second conditioning period at −30° C. for over 1 hr (where humidity is not controlled). Subsequently, the test specimens are tested at −30° C., immediately following the second conditioning period. For impact testing conditions, the pendulum capacity is 4 Joules.

### Tensile Method

The sample compositions of the Examples were tested for tensile properties using the procedure described in ISO 527. The test specimen used in the test is a flat test specimen made from the composition with the following dimensions: 165 mm length×10 mm width×4 mm thickness.

The test specimen is extended along the specimen's major longitudinal axis at a constant speed until the specimen fractures or until the stress (load) or the strain (elongation) reaches a predetermined value. During this procedure, the load sustained by the specimen and the elongation are measured. Using an Instron 5566 instrument the tensile property of the test specimen is measured as follows: (1) the test parameters are a temperature of 23.0° C.±2° C. and a 50%±10% RH; and (2) the load cell is at 10 KN with a test speed of 50 mm/min.

### Flexure Method

The relationship between stress and strain of a test specimen made of plastic material, while the specimen is being bent or flexed, i.e., the flexural properties of the specimen, can be determined with the test method described in ISO 178. The ISO 178 test method was used to determine the flexural properties test specimens made from the compositions of the Examples by performing a “three-point bend test” on a universal testing system. The three-point bend test applies force at the midpoint of a rectangular specimen, which is freely supported at either end. The dimensions of the rectangular specimen used were: 80 mm length×10 mm×4 mm thickness. The applied force is measured by a load cell, and the resulting deflection is measured by either the system's crosshead displacement or by a direct strain measurement device. A deflectometer was used to determine modulus. The test machine used is an Instron 5566 instrument and is maintained a constant test speed between 1 mm/min and 500 mm/min.

The test specimen of rectangular cross-section, resting on two supports, is deflected by means of a loading edge acting on the specimen midway between the supports. The test specimen is deflected in this way at a constant rate at midspan until rupture occurs at the outer surface of the specimen or until a maximum strain of 5% is reached, whichever occurs first. During this procedure, the force applied to the specimen and the resulting deflection of the specimen at midspan are measured. The Instron 5566 instrument is used for the test and the test in conducted using the following parameters: a temperature of 23.0° C.±2° C. and a 50%±10% RH. And, the load cell was used at 1 KN, and at a test speed of 1.3 mm/min.

### Melt Index Method

The test method used in the Examples for determining melt index (MI) is ASTM-D1238 which describes a process for determining the melt flow rate of an extrusion of molten thermoplastic resin using an extrusion plastometer.

After a specified preheating time, the molten resin is extruded through a die with a specified length and orifice diameter under prescribed conditions of temperature, load, and piston position in the barrel. The instrument used in the Examples was a Tinus Olsen MP600N. The parameters used were a temperature of 235° C. and a load weight of 5 kg.

### HDT Method

The test method described in ISO 75 was used in the Examples to determine the temperature at which a test specimen deflects a specified amount when loaded in 3-point bending at a specified maximum outer fiber stress. The temperature of deflection under load (flexural stress under three-point loading) of a plastic specimen as determined by the above method is referred to as the heat deflection temperature (HDT). The HDT can be used to determine short-term heat resistance of a specimen.

In testing a specimen, the test specimen is placed on the supports so that the longitudinal axis of the specimen is perpendicular to the supports. A loading assembly is then placed in a heating bath; and a force, calculated to give a flexural stress 0.45 MPa (pressure unit) in the test specimen, is applied to the test specimen as specified in the relevant part of ISO-75. Five minutes after first applying the force to the specimen, the reading of the deflection-measuring instrument is set to zero. Then, the temperature of the bath is raised at a uniform rate of (120° C./hr±10° C./hr. The temperature at which the initial deflection of the bar has increased by the standard deflection is recorded.

### Inventive Examples 1-3 and Comparative Examples A-C

The nylon compositions described in Table V were prepared and tested.

TABLE V
Nylon Compositions

| Example No. | Nylon | Modifier |
|---|---|---|
| Comp. Ex. A | 80 wt % Zytel 7304 NC010 | 20 wt % Modifier 1 |
| Inv. Ex. 1 | 80 wt % Zytel 7304 NC010 | 20 wt % Modifier 2 |
| Comp. Ex. B | 80 wt % PA6-YH800 | 20 wt % Modifier 1 |
| Inv. Ex. 2 | 80 wt % PA6-YH800 | 20 wt % Modifier 2 |
| Comp. Ex. C | 80 wt % PA6-YH800 | 20 wt % Modifier 3 |
| Inv. Ex. 3 | 80 wt % PA6-YH800 | 20 wt % Modifier 4 |

### General Procedure for Producing the Nylon Blend Compositions

The nylon compositions described in Table V were prepared using the following general procedure: Nylon6 resin in pellet form and the modifier pellets produced as described above were compounded in a twin screw extruder to form the toughened nylon composition. The barrel temperature of the extruder was set in a range of from 220° C. to 250° C. The screw speed of the extruder was set at 250 rpm. The output speed of the extruder was set at 10 kg/hr.

### Inventive Example 4 and Comparative Example D

The nylon compositions described in Table V were used to prepare molded specimens (Inv. Ex. 4 and Comp. Ex. D) described in Table VI for testing the performance of the nylon composition. The pellets of the PA6-YH800 compounds described in Table V were dried at 105° C. for 4 hr before using the pellets for injection molding. A FANUC ROBOSHOT S-20001b injection molding machine was used for fabricating the molded test specimens using the PA6-YH800 based compounds described in Table V. The following molding process conditions were used to obtain the results of testing the molded specimens described in Table VI: the barrel temperature was set as 50° C./250° C./260° C./260° C./260° C./260° C.; the mold temperature was 60° C.; the injection speed was 30 mm/s; the injection pressure was 25 MPa; the injection time was 1.2 s; the hold pressure was 20 MPa; and the cooling time was 10 s. The molded specimens were tested using the test methods described above in the TEST METHODS AND MEASUREMENTS section.

Table VI describes the general mechanical performance of the molded specimens including Comp. Ex. D and Inv. Ex. 4. The RT and −30° C. impact strength was tested using CHARPY ISO 179. The flexure performance was tested using ISO178, and the melt index was tested using ASTM-D1238. The tensile testing was conducted according to ISO 527, and HDT was generated according to ISO 75 as described above. Table VI indicates the molded specimen of Inv. Ex. 4 (made from the composition of Inv. Ex. 1) shows a significantly higher impact strength (both at RT and −30° C.); and a higher flexure strength at yield and a higher HDT than the comparative molded specimen of Comp. Ex. D (made from the composition of Comp. Ex. A). The results in Table VI also show that the tensile strength at yield is maintained at a similar level for both molded specimens of Inv. Ex. 4 and Comp. Ex. D.

The results in Table VI also indicate that the molded specimen of Inv. Ex. 4 has a better overall mechanical property and a heat resistance property than the molded specimen of Comp. Ex. D. In addition, the melt index results described in Table VI also indicate that the composition of Inv. Ex. 1 used to make the test molded specimen of Inv. Ex. 4 has better flowability than the composition of Comp. Ex. A used to make the test molded specimen of Comp. Ex. D. Therefore, the results in Table VI supports that a SLFC having DA characteristics is a higher efficiency impact modifier than a conventional impact modifier made from a POE-g-MAH.

TABLE VI
Properties of Molded Specimens

| | Comp. Ex. D | Inv. Ex. 4 |
|---|---|---|
| | (Used | (Used |
| | Composition | Composition |
| | of Comp. | of Inv. |
| Property Tested | Ex. A) | Ex. 1) |
| Impact strength: Room Temperature | 38.64 | 53.84 |
| Impact Strength (KJ/m²) | | |
| Impact strength: −30° C. temperature | 22.80 | 24.93 |
| impact strength (KJ/m²) | | |
| Flexure: Strength at Yield (MPa) | 55.24 | 68.73 |
| Melt Index (g/10 min) at 230° C., 5 kg* | 1.5 | 2.6 |
| Tensile: Strength at Yield (MPa) | 47.1 | 48.0 |
| Heat deflection temperature (HDT): ° C. | 50.3 | 54.2 |

Notes for Table VI:
*The MI of the pellets made from the Compositions was measured and not the molded specimen.

### Inventive Example 5 and Comparative Examples E and F

The PA6-YH800 compound and the Nylon 6 compounds were compounded with the impact modifier to form the nylon compositions described in Table V; and the compounded materials were used to prepare sample molded specimens for testing the performance of the nylon compositions. The molded specimens were molded using the same molding process described above in Inv. Ex. 4 and Comp. Ex. D; and the molded specimens were tested using the test methods described above in the TEST METHODS AND MEASUREMENTS section. The results of testing the molded specimens are described in Table VII.

Table VII describes the general mechanical performance of the PA6-YH800 based nylon composition including both Comp. Ex. E and F and Inv. Ex. 5. The RT and −20° C. impact strength was tested using CHARPY ISO 179, and the flexure performance was tested using ISO178. The melt index was tested according to ASTM-D1238, and the tensile tests and HDT were done according to ISO 527 and ISO 75, respectively, as described above. Table VII indicates that the test molded specimen of Inv. Ex. 5 (made from the composition of Inv. Ex. 2) shows significantly higher impact strength (both at RT and at −20° C.) than the test molded specimen of Comp. Ex. E (made from the composition of Comp. Ex. B), supporting that the molded specimen of Inv. Ex. 2 has a better mechanical property than the molded specimen of Comp. Ex. E. Meanwhile, the melt index results also indicate that the molded specimen of Inv. Ex. 5 has a slightly better flowability than the molded specimen of Comp. Ex. E.

TABLE VII
Properties of Molded Specimens

| | Inv. Ex. 5 | Comp. Ex. E | Comp. Ex. F |
|---|---|---|---|
| | (Used | (Used | (Used |
| | Composition | Composition | Composition |
| | of Inv. | of Comp. | of Comp. |
| Property Measured | Ex. 2) | Ex. B) | Ex. C) |
| Room Temperature Impact | 67.17 | 44.99 | 56.59 |
| (KJ/m²) (higher is better) | | | |
| −20° C. Impact | 48.92 | 41.23 | 61.18 |
| (KJ/m²) | | | |
| Tensile Strength at Yield | 1,408.8 | 1,477.5 | 1,401.7 |
| (MPa) | | | |
| Flexure-Strength at Yield | 63.52 | 62.38 | 52.18 |
| (MPa) | | | |
| MI (g/10 min) at 230° | 16.2 | 15.5 | 25.4 |
| C., 5 kg* | | | |

Notes for Table VII:
*The MI of the pellets made from the Compositions was measured and not the molded specimen.

Based on all the results described above, the modifiers used in Inv. Ex. 1-5 have significantly better toughening efficiency compared to the modifiers used in Comp. Ex. A-F. Therefore, a tougher nylon composition of the present invention having better flow can be provided to, for example, the auto industry for use in automotive applications.

### OTHER EMBODIMENTS

One embodiment of the toughened nylon composition of the present invention includes the use of an ethylene-octene high performance low density polyolefin elastomer for the base polyolefin elastomer used to make the SLFC.

In another embodiment, the method of the present invention for making the toughed nylon composition includes the steps of: (A) grafting at least one furan compound onto at least one MAH-grafted polyolefin elastomer to form a furan moiety-grafted polyolefin elastomer (e.g., POE-g-FFA); (B) compounding the resulting furan moiety-grafted polyolefin elastomer from step (A) with at least one maleimide compound to form the SLFC modifier; and then (C) mixing the SLFC modifier, component (b), with at least one polyamide, component (a). In a preferred embodiment, the at least one modifier, component (b), is a substantially linear functionalized ethylene/alpha-olefin copolymer having at least one side chain furan moiety and at least one side chain maleimide structure.

In other embodiments, the concentrations of components used in the method of manufacturing the nylon composition includes, for example, from 70 wt % to 98 wt % of the at least one polyamide, component (a), and from 2 wt % to 30 wt % of the at least one modifier, component (b), based on the weight of components (a) and (b).

In still other embodiments, the SLFC impact modifier of the present invention includes a mixture of: (bi) at least one MAH-grated polyolefin elastomer compound; (bii) at least one furan-grated polyolefin elastomer compound; and (biii) at least one maleimide compound; and a method of manufacturing the nylon composition using the above SLFC modifier.

In yet another embodiment, the method of manufacturing the nylon composition of the present invention includes the steps of: (A) grafting (bi) the at least one MAH-grated polyolefin elastomer compound (e.g., POE-g-MAH) with (bii) the at least one furan compound to form a furan moiety-grafted polyolefin elastomer (e.g., POE-g-FFA); and then (B) compounding the resulting furan moiety-grafted polyolefin elastomer from step (A) with a (biii) the at least one maleimide compound such that at least one side chain furan moiety crosslinks with at least one maleimide structure of the maleimide compound to form the SLFC modifier; and then (C) blending the SLFC modifier with a polyamide.

In even still other embodiments, the method of producing the SLFC modifier of the present invention can include the alternative steps of: either (1) compounding the furan moiety-grafted polyolefin elastomer (e.g., POE-g-FFA) and the crosslinker bismaleimide (BMI) compound with the ethylene copolymer; or (2) soaking the furan moiety-grafted polyolefin elastomer (e.g., POE-g-FFA) and the BMI into the ethylene copolymer.

What is claimed is:

1. A nylon composition comprising a blend of:
(a) at least one polyamide; and
(b) at least one modifier; wherein the modifier is a substantially linear functionalized ethylene/alpha-olefin copolymer having at least one side chain furan moiety crosslinked with at least one maleimide structure.

2. The composition of claim 1, wherein the composition exhibits at least a 10 percent increase in room temperature impact strength compared to an unmodified substantially linear functionalized ethylene/alpha-olefin copolymer having no side chain furan moieties and no side chain maleimide structures.

3. The composition of claim 1, wherein the at least one side chain furan moiety of the substantially linear functionalized ethylene/alpha-olefin copolymer is produced by modifying the ethylene/alpha-olefin copolymer with furfurylamine; and wherein the at least one maleimide structure of the substantially linear functionalized ethylene/alpha-olefin copolymer is produced by modifying the ethylene/alpha-olefin copolymer with 1,1′-(methylenedi-4,1-phenylene)bismaleimide.

4. The composition of claim 1, wherein the concentration of (a) the at least one polyamide is from 70 weight percent to 98 weight percent, based on the weight of components (a) and (b); and wherein the concentration of (b) the at least one modifier is from 2 weight percent to 30 weight percent, based on the weight of components (a) and (b).

5. The composition of claim 1, wherein the polyamide is selected from the group consisting of a polycaprolactam, a polyamide comprising a hexamethylene diamine-adipic acid condensation product, or combinations thereof.

6. The composition of claim 1, wherein the substantially linear functionalized ethylene/alpha-olefin copolymer having at least one side chain furan moiety is made by converting maleic anhydride groups present in the substantially linear functionalized ethylene/alpha-olefin copolymer to furan groups at a conversion level of at least 80 percent.

7. The composition of claim 1, wherein the modifier has a density of less than 0.900 g/cm³.

8. The composition of claim 1, wherein the modifier provides the composition with a thermo-reversibility property via a reversible crosslink Diels-Alder-type reaction.

9. The composition of claim 1, wherein the composition further comprises up to 50 weight percent, based on the composition, of a filler selected from the group consisting of glass fiber, calcium carbonate, calcium silicate, calcium sulfate, magnesium carbonate, barium sulfate, barite, alumina, hydrated alumina, mica, clay, silica or glass, fumed silica, titanium dioxide, titanates, talc, flame retardants, carbon black or graphite, antimony oxide, magnesium hydroxide, borates, and combinations thereof.

10. An article manufactured from the composition of any of the previous claims.
